(19) United States
(12) Patent Application Publication
(10) Pub. No.: US 2004/0128690 A1
(43) Pub. Date: Jul. 1, 2004

(54) Apparatus, method and a computer readable medium for providing interactive services

(76) Inventor: Yosef Zohar Ariely, Ramat Hasharon (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/335,015

(22) Filed: Dec. 31, 2002

(51) Int. Cl. H04N 7/173

(52) U.S. Cl. 725/86; 725/110; 725/112; 725/113

(57) ABSTRACT

An apparatus and method for providing an interactive service to an end-user, the method includes: providing a program to an end-user; detecting a request to participate in an interactive service; and initializing an interactive session and enabling the end-user to receive a delayed program in response to a progress of the interactive service.

### FIELD OF THE INVENTION

The present invention relates to a scheme for providing interactive services (e.g., interactive television services) to end-users in a manner that allows end-users to view both the interactive service and other programming.

### BACKGROUND

Advertisements are an integral part of many television channels and internet sites. They reduce the cost of entertainment services that are provided to an end-user, as the cost associated with service providers, content providers and the like are partially covered by the advertisements.

Advertisements are aimed to increase the overall income of the advertised services/product, and various market surveys and other techniques are implemented to determine the advertisement's efficiency.

Accordingly, there is a need to provide a system and method for providing effective advertisements that may benefit both the end-users and the industry.

The effectiveness of an advertisement is influenced by the number of end-users that actually view it. It must be viewed by at least a significant number of end-users. In an era where each end-user receives multiple channels and is able to skip advertisement, the task of providing an effective advertisement is getting harder.

A new method for providing a more attractive advertisement is the interactive advertisement.

Various interactive services are offered to end-users, via various networks and end-user devices. A very common end-user device includes a set-top-box and a television, although many others end-user devices are available. Interactive services require the participation of an end-user, said participation may involve a selection or a navigation by end-user.

One of the most common interactive services is interactive advertisement. During an interactive advertisement session an end-user may exchange information with the advertiser, purchase items, order brochures or other purchase-related items, and the like. During the interactive session the end-user may be presented with interactive or non-interactive screens, be linked to a web site, and the like.

When interactive advertisement are integrated within a program, a viewer may refrain from initiating an interactive session or may limit the duration of the interactive session in order not to miss portions of the program. This timing limitation reduces the effectiveness of the interactive advertisement.

Time shifting techniques enable an end-user to receive a delayed version of a television program, thus enabling an end-user that temporarily stopped watching the program to restart watching the program. U.S. patent application Ser. No. 20,010,051,516 of Nakamura et al. describes a system and method for skipping non-interactive commercials by supplying predefined selected scenes during commercials. Nakamura et al. also describes a prior art method of automatic change of channels when advertisements are detected and yet another method of displaying a web page once the advertisement is detected.

### SUMMARY OF THE INVENTION

In one embodiment, the invention provides an apparatus for providing an interactive service to an end-user, the apparatus includes: (i) means for providing a program to an end-user; (ii) a detector, communicatively connected to the end-user, for detecting a request to receive an interactive service; and (iii) an interactive service provider, also communicatively connected to the end-user, for providing the interactive service and for enabling the end-user to receive a delayed program in response to the progress of the interactive service. According to an aspect of the invention the apparatus further includes a monitor, coupled to the interactive provider, operative to determine a delay of the delayed program.

The invention also provides a method for providing an interactive service to an end-user, the method includes the steps of: (i) providing a program to an end-user; (ii) detecting a request to participate in an interactive service; and (iii) providing the interactive service and enabling the end-user to receive a delayed program (or part of a program) in response to a progress of the interactive service.

The method may include an additional step of monitoring the interactive service to determine a delay of the delayed program. The delay may reflect the overall duration of the provision of the interactive service, but this is not necessarily so. For example, if there are time periods during which both the interactive service and the program may be simultaneously provided to the end-user without significantly reducing the end-user's ability to concentrate on the program, the delay may reflect only time periods during which a participation in an interactive service does not allow an effective display of the program.

Step (iii) of enabling, above, may include linking the end-user to the delayed program, and/or generating the program (either at the end-user device or at other locations).

According to another aspect of the invention the method further includes a step of monitoring the program and providing a relevancy factor to various portions of the program. The relevancy factor may reflect the possibility that an end-user or a group of certain end-users will require to view the portion. It is noted that the relevancy factor may also be time-dependent, as older events are usually less relevant that newer events. The relevancy factor may be utilized for providing (even via multicast channels) high relevancy portions to multiple end-users.

According to an aspect of the invention once (or after) the interactive session ends the end-user receives a delayed program that is delayed by a delay period that is responsive to the length of the interactive service. This is not necessarily so as the end-user may request to receive the delayed program prior to the end of the interactive session.

According to an aspect of the invention, after the delayed program is provided to the end-viewer, the end-user may close the time gap between the delayed program and the program by various means, such as skipping and/or fast forwarding predefined advertisements. These predefined advertisements may be associated with the interactive service or may be associated with a program provider that provides the program. The gap may be closed by skipping and/or fast forwarding irrelevant portions of the program.

### BRIEF DESCRIPTION OF THE DRAWINGS

Further features and advantages of the invention will be apparent from the description below. The invention is herein described, by way of example only, with reference to the accompanying drawings, wherein:

FIGS. 1 and 7 illustrate systems for providing interactive services and their environments, in accordance with an aspect of the invention;

FIGS. 2-4 illustrate methods for providing interactive services, in accordance with aspects of the invention;

FIG. 5 illustrates another system for providing interactive services and its environment, in accordance with another aspect of the invention; and

FIGS. 6A-6C illustrate several displays, in accordance with embodiments of the invention.

### DETAILED DESCRIPTION

The terms “program”, “movie”, and “stream” as used herein include sequences of audio and/or visual information. For convenience of explanation the following description relates to Internet Protocol (IP) and head-ends but other configurations, as well as other communication protocols and other information formats may be utilized without departing from the scope of the invention.

The terms “interactive service”, and “interactive session” include an exchange of information with an end-user, exchange of information between end-users, and various actions, usually in response to the end-user selection. It may include interactive advertisements, interactive games, interactive information providers, and the like. Usually, the participation in an interactive service reduces the end-user's ability to concentrate on a received program (and it may even prevent his ability to view the program), but this is not necessarily so.

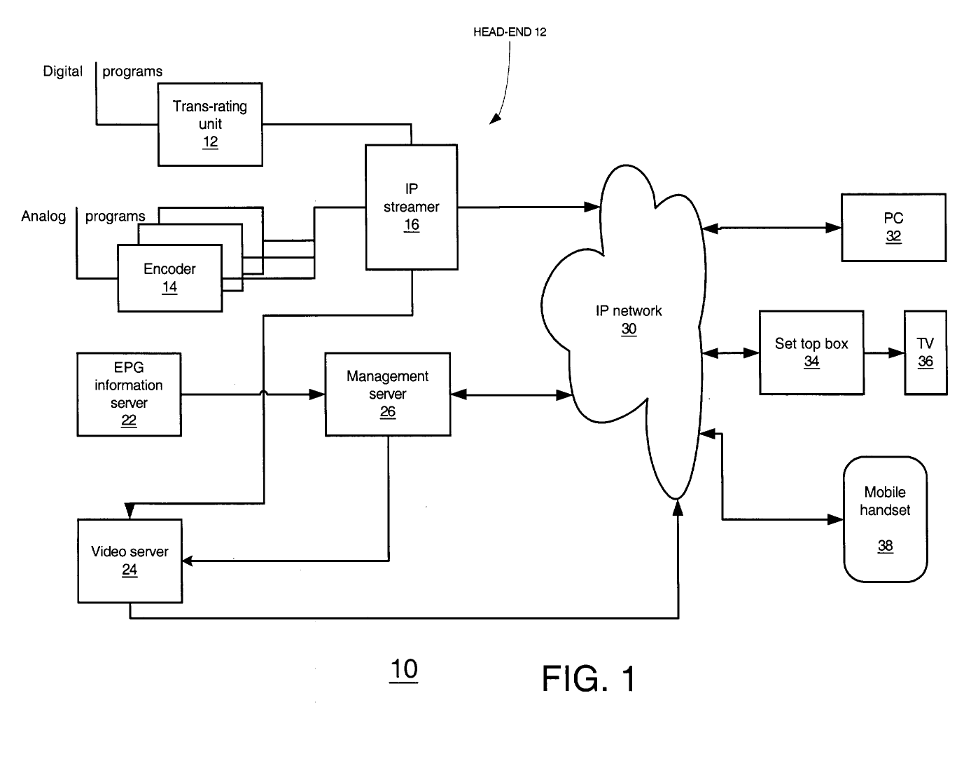

FIG. 1 illustrates an IP-oriented system 10 that includes head-end 11, IP network 30 and multiple end-user devices. Head-end II is connected to various media sources, such as digital satellites, analog satellites, content providers, VCRs, video cameras and the like (all not shown). Head-end 11 may also receive programs via various communication networks, such as the Internet (not shown).

Head-end 11 is connected, via IP network 30, to multiple end-users, and more exactly to end-user devices, such as personal computer (PC) 32, set-top box 34 and television 36, and mobile handset 38. Usually, a large number of end-users are connected to a single head-end 11, but for simplicity of explanation only a small number of end-user devices are illustrated.

Head-end 11 may utilize both unicast and multicast broadcasts in order to provide programs, delayed programs and interactive services to end-users. Usually, programs are multicast while delayed programs are unicast, but this is not necessarily so. Delayed programs may be multicast whenever many end-users request to receive the same delayed programs, and/or whenever a highly relevant event occurs and/or when there are vacant multicast channels.

Head-end 11 may be operable to implement various redundancy, load-balancing, and control and allocation schemes to enable reliable and fast provision of programs to end-users.

Head-end 11 may receive live programs and generate delayed programs by storing the program in a memory unit within the head-end. The delayed programs may be stored at a central database, such as a database within video server 24, but may also be distributed among various databases, thus defining either a centralized or distributed memory architecture.

By allocating pointers to various locations within said databases multiple delayed programs (associated with distinct time gaps) may be generated.

Management server 26 is operable to coordinate the storage of programs that are output from AST-IP streamer 16 to video server 24. Management server 26 is also operable to perform asset management by associating programs, delayed programs, program associated information (such as EPG information), advertisements and video on demand files with unique identification values. Management server 26 further allows end-users to utilizes these unique identification values in order to selectively receive programs, delayed programs, interactive services, and the like.

Accordingly, once an end-user requests a certain program, the request is transmitted upstream from the end-user device, through IP network 30, to management server 26 and is converted (either by the end-user device or by head-end 11) to a request to receive a uniquely identified program, delayed program, interactive service, and the like. For example, when IP and HTTP (hypertext transfer protocol) protocols are used, the unique identifier is a URL. The management of the various programs, delayed programs and additional information (such as an electronic programming guide—EPG) enables the combination of content from various sources.

Digital streams are acquired by trans-rating unit 12 that may change the bit rate of the acquired digital streams. Analog streams may be acquired by encoder 14 (out of multiple encoders) and converted into a digital stream. The outputs of multiple encoders may be multiplexed to provide a multiplexed stream. The streams from encoder 14 as well as from trans-rating unit 12 are provided to ASI-IP streamer 16 that, in turn, de-multiplexes the streams and sends the streams as IP multicast packets to IP network 30. The streams are further provided, via management server 26, to video server 24 to be temporarily stored (e.g., to be later retrieved as delayed programs). Video server 24 is also operable to provide video-on-demand service, for selective retrieval of movies. It is noted that FIG. 1 illustrates an exemplary system 10, but other systems having other configurations, as well as other communication protocols and network may also utilized. For example, the present methods (discussed below) may be implemented for various communication media, including cable TV media, HFC networks and the like.

The invention provides a combination of various entities, such as: (i) means for providing a program to an end-user, (ii) a detector for detecting a request to receive an interactive service, (iii) an interactive service provider, (iv) a monitor for determining a delay of the delayed program, and (v) a program relevancy monitor. It is noted that these various means may be included within system 10 (as illustrated at FIG. 1), but this is not necessarily so.

Referring to FIG. 1, the detector may include a software and/or hardware entity located within management server 26, operable to receive upstream transmissions from end-user devices, either via IP network 30 or via other bypassing upstream links. The interactive software provider may be a software and/or hardware entity located within EPG information server 22, management server 26 or video server 24, that is able to exchange information and control signals with end-user devices to facilitate the interactive service. The monitor may be located within the end-user device or within management server 26. The program relevancy monitor requires a display (not illustrated at FIG. 1) and is usually located within head-end 11 or is remotely connected to said head-end.

Video server 24, in co-operation with management server 26, may embed advertisements within a program. According to an aspect of the invention, the end-user may select between various versions of a program, where the versions differ by the number of commercials contained therein. Accordingly, the cost of the different program versions may decline as the number of advertisements contained therein rise.

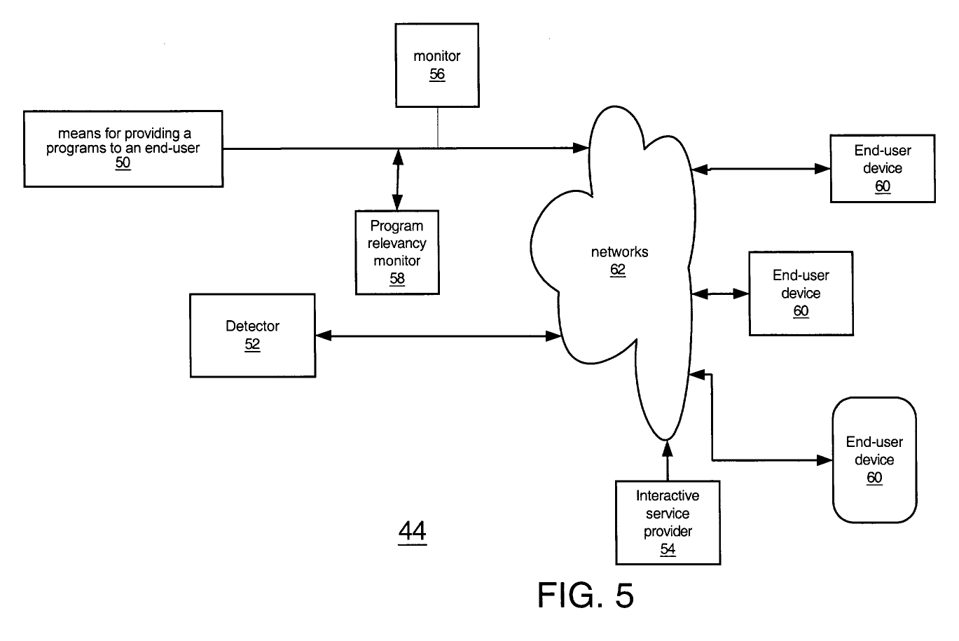

FIG. 5 illustrates apparatus 44 for providing an interactive service to an end-user. Apparatus 44 includes means 50 for providing a program to an end-user, detector 52 for detecting a request to receive an interactive service, interactive service provider 54 for providing the interactive service and for enabling the end-user to receive a delayed program (or part of a program) in response to a progress of the interactive service. It is noted that some of these entities and/or some or their functionality may be located within the end user devices and/or provided by the end user devices respectively.

Apparatus 44 may further include monitor 56 that determines a delay of the delayed program, and even program relevancy monitor 58 for monitoring the program and for providing a relevancy factor to various portions of the program. Apparatus 44 is connected to multiple end-user devices 60 via networks 62.

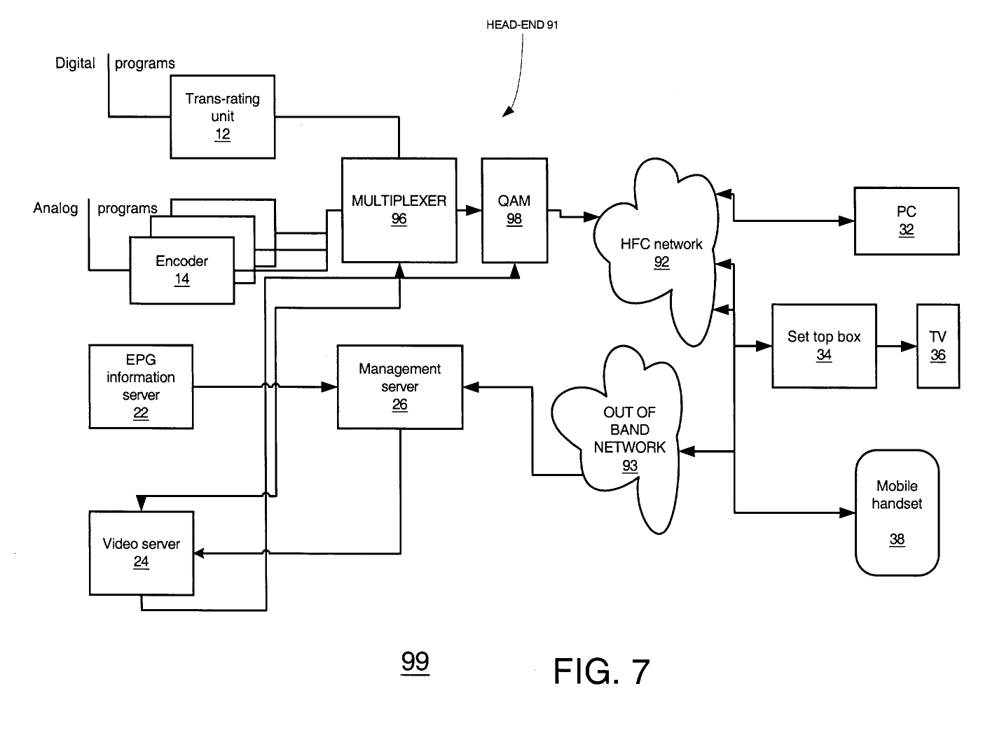

FIG. 7 illustrates apparatus 99 for providing an interactive service to an end-user. System 99 of FIG. 7 resembles system 10 of FIG. 1, but differs from said system as system 10 is IP oriented, while system 99 is cable oriented. Accordingly, IP streamer 16 of FIG. 1 is replaced by multiplexer 96 and QAM 98, IP network 30 of FIG. 1 is replaced by Hybrid Coax Fiber network 92 and Out Of Band network 93. Video server 24 is connected to QAM 98 and multiplexer 96, the trans-rating unit 12 and encoders 14 are connected to the multiplexer 96. The multiplexer is connected to QAM 98 that in turn is connected to HFC network 92.

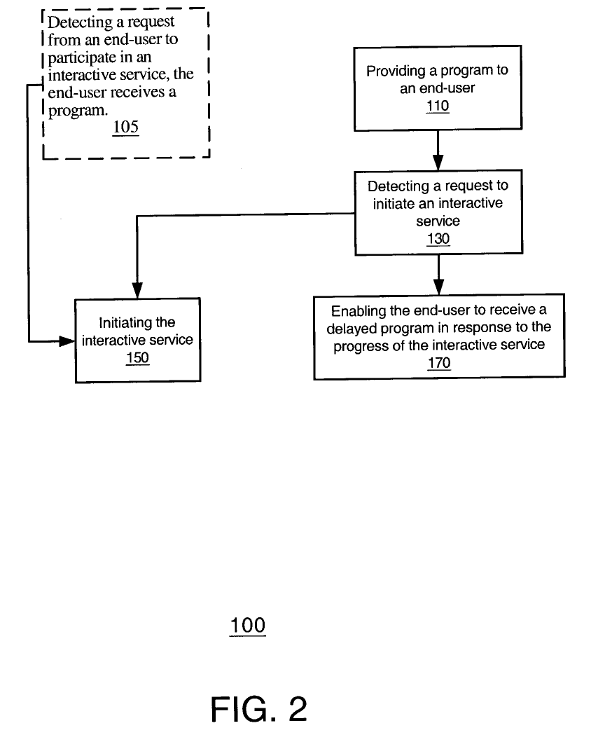

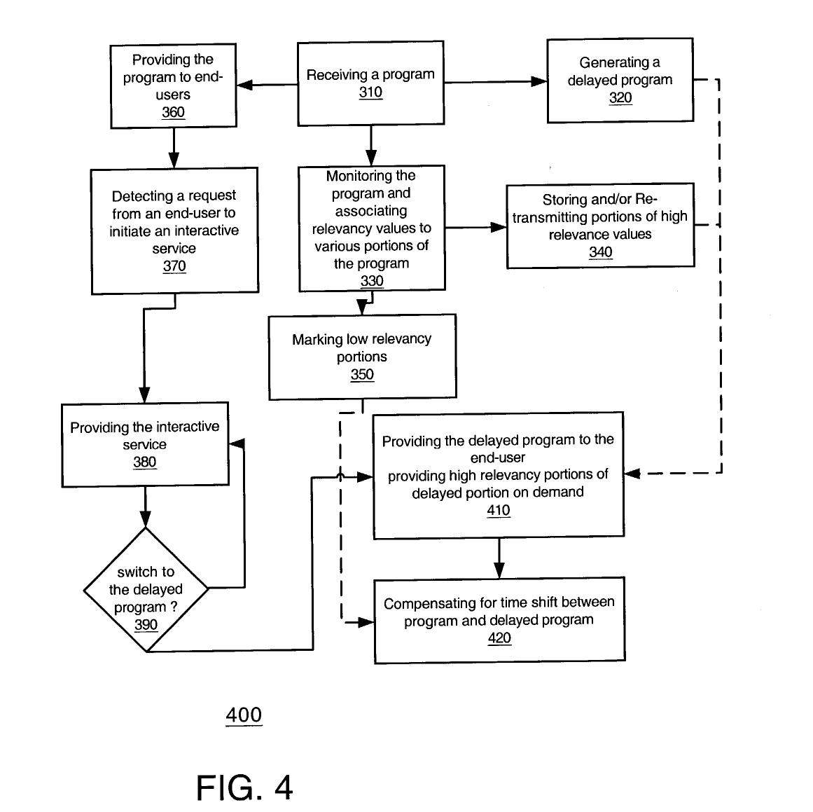

FIGS. 2-4 illustrate various methods 100-400 for providing interactive services, in accordance to various aspects of the invention. It is noted that these methods, and especially method 400 of FIG. 4 are mainly implemented by head-end 11, but this is not necessarily so. Many steps of these methods, and especially any of the steps of: (i) generating a delayed program, (ii) providing the delayed program to the end-user, and (iii) compensating for time shifts between the delayed program and the program, may be implemented by the end-user device. End-user devices that are equipped with relatively large storage media are able to support relatively long delay.

FIG. 2 is a flow diagram illustrating method 100 for providing interactive services to end-users. Method 100 starts by step 110 of providing a program to an end-user.

The end-user may receive the program by various end-user devices, such as but not limited to personal computers, lap-top computers, palm and/or hand-held computers, PDAs, cellular phones and the like. The program may include audio and/or visual content. Such a program may be a television program, but his is not necessarily so. Referring to FIG. 1, the program may originate from an analog program source, digital program source, video on demand server and the like. The program may be a real time broadcasted program but may also be a time shifted program.

Step 110 is followed by step 130 of detecting a request to participate in an interactive service. The request may be responsive to a previously provided interactive initiating content, such as a previously provided icon or advertisement banner that encourages an end-user to participate in an interactive service. The interactive initiating content may be displayed during one or more portions of the program but may also be displayed as a result of an action of an end-user.

For example, the end-user may be sent a list of currently available interactive services. The availability of these interactive services may be responsive to the content of the currently displayed program, to a previously displayed program, to the end-user viewing patterns, to the end-user profile, to other end-users profiles, the available bandwidth and the like.

It is noted that the device that provides the interactive service may differ than the apparatus that manages the provision of an interactive service.

As illustrated by the dashed step 105, steps 110 and 130 may be replaced by step 105 of detecting a request from an end-user to participate in an interactive service, in response to which the end-user receives a program.

Step 130 is followed by step 150 of participating in an interactive session/receiving an interactive service/initializing an interactive service and step 170 of enabling the end-user to receive a delayed program in response to the progress of the interactive service. In order to receive an interactive service the end-user may initiate at least one interactive session.

It is assumed that once an interactive session begins the end-user cannot effectively view the program. For example, the interactive service may involve a display of interactive content over most or even all of the display. It is noted that an end-user may not effectively concentrate on the program even when the interactive content is not displayed on most (or all) of the display.

Step 170 of enabling includes the generation of a delayed program and allowing the end-user to access the delayed program. The delaying and enabling may take various forms. According to one aspect of the invention the end-user device has a limited capacity to store program portions. The limited availability is proportional to the maximal delay between the program and a delayed program, assuming that the end-user-device receives from one hand the program and outputs, on the other hand, a delayed program. According to another aspect of the invention the delayed program is generated at a remote location and stored at a remote storage device, such as at a storage device within video server or other remote memory unit, and the method also includes a step of enabling the end-user to access that remote storage device. The delayed program may be generated automatically, in response to predefined parameters such as asset management parameters (that may include available storage space, available network bandwidth, and the like). The generation of a delayed program may be responsive to end-user requests or to commands from the head-end administrator.

Whenever such a delayed program is generated the method shall enable the end-user to access the delayed program. This may include linking the end-user to the delayed program, allocating bandwidth and/or other network resources for the transmission of the delayed program, and the like.

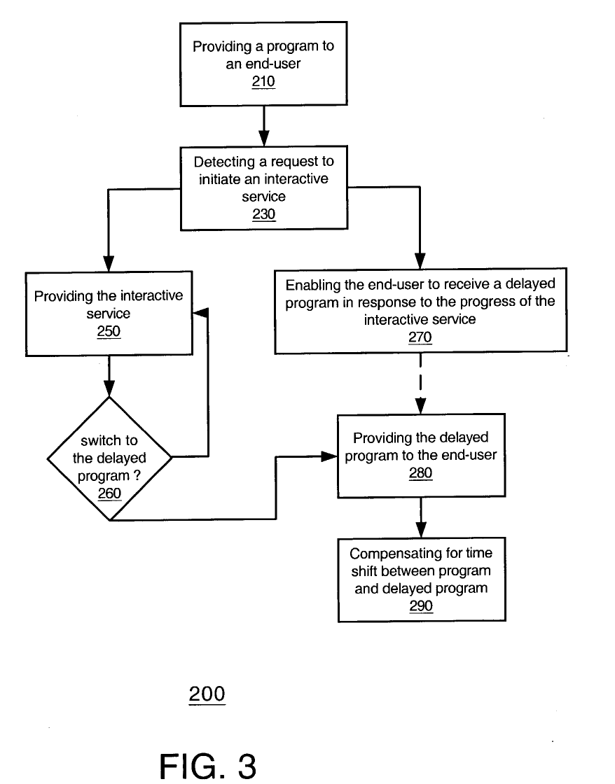

FIG. 3 further illustrates method 200 for providing an interactive service to an end-user. Method 200 starts by step 210 of providing a program to an end-user. Step 210 is followed by step 230 of detecting a request to initiate an interactive service. Step 230 is followed by steps 250 and 270. Step 250 includes providing the interactive service. Step 270 includes enabling the end-user to receive a delayed program in response to the progress of the interactive service. Step 250 is followed by query step 260 of determining whether to switch to the delayed program (jump to step 280) or keep providing the interactive service (jump to step 250). Step 280 involves providing the delayed program to the end-user. The dashed line that extends from step 270 to step 280 indicates that the delayed program may be provided after the end-user is enabled to access/receive the delayed program. Step 280 is followed by step 290 of compensating for a time shift (time gap) between the program and the delayed program.

FIG. 4 illustrates method 400 for providing interactive services to end-users. Method 400 starts by step 310 of receiving a program. Step 310 is followed by steps 320, 330 and 360. Step 320 includes generating a delayed program.

Step 330 includes monitoring the program and associating relevancy (otherwise termed interest) values to various portions of the program. Step 330 involves viewing the program and associating, either in real time or not, relevancy values. These portions may be of a predefined length but usually correspond to events that are shown during the program. Step 330 is followed by step 350 of marking low relevancy portions.

Step 360 involves providing the program to end-users. Step 360 is followed by step 370 of detecting a request to provide an interactive service to an end-user. Step 370 is followed by step 380 of providing the interactive service to the end-user and determining when to receive the delayed program, as illustrated by query step 390. Step 390 is followed by step 410 of providing the delayed program to the end-user and providing high relevancy portions of the delayed program in response to end-user requests.

It is noted that the initialization of an interactive service and the request to initiate in an interactive service, may be responsive to visual and/or audio objects that are displayed to the end-user. It is further noted that the provision of high relevancy portions may also be accompanied by a provision of audio/visual objects to the end-user that notify the end-user of the availability of these program portions. For example, assuming that a football match is live broadcast and that a goal is scored. The end-user may be presented with an “instant replay” icon that enables the end-user to review the events that led to the goal. If there are many high relevancy events, the end-viewer may be able to select between multiple audio/visual objects.

Step 410 is followed by step 420 of compensating for time shifts between the delayed program and the program.

The dashed lined extending from steps 320 and 340 to step 410 and from step 350 to step 420 illustrate that step 410 should not occur prior to steps 320 and 340, and step 420 should not occur before step 350.

The relevancy ranking may be useful in various events, such as when the program is a live broadcast sport event. For example, assuming that the program is a live sport event, such as a football match, various events such as scoring a goal, controversial events, penalties and the like may be very relevant while other events, such as the providing medical treatment to an injured player, or other events that stop the flow of the match may be of low relevancy.

According to yet a further aspect of the invention the relevancy may be determined in response to requests to review a certain event (by other end-users).

It is noted that the provision of the delayed program to the end-user may start (i) when (or after) the interactive service ends, (ii) when the displaying of the interactive service does not interfere with the delayed program, (iii) when the program and the interactive service may be presented simultaneously to the end-viewer, and/or (iv) in response to the end-user's request to resume watching the program.

Step 410 of compensating for a time gap between the program and the delayed program may involve skipping or fast-forwarding predefined advertisements, such as but not limited to, predefined advertisements that are associated with the interactive service and/or that are associated with a program provider that provides the program.

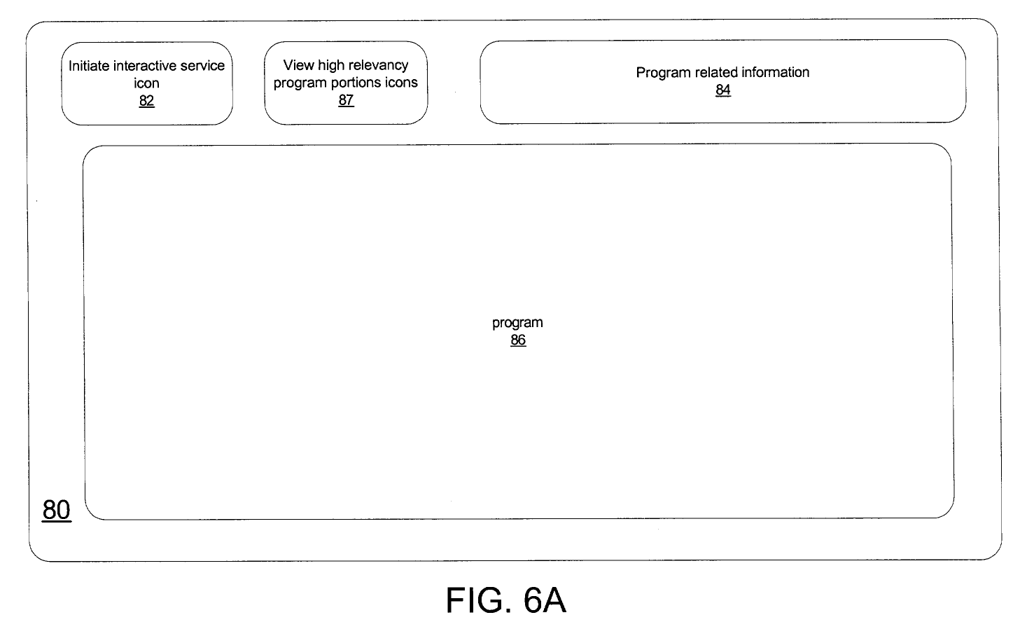

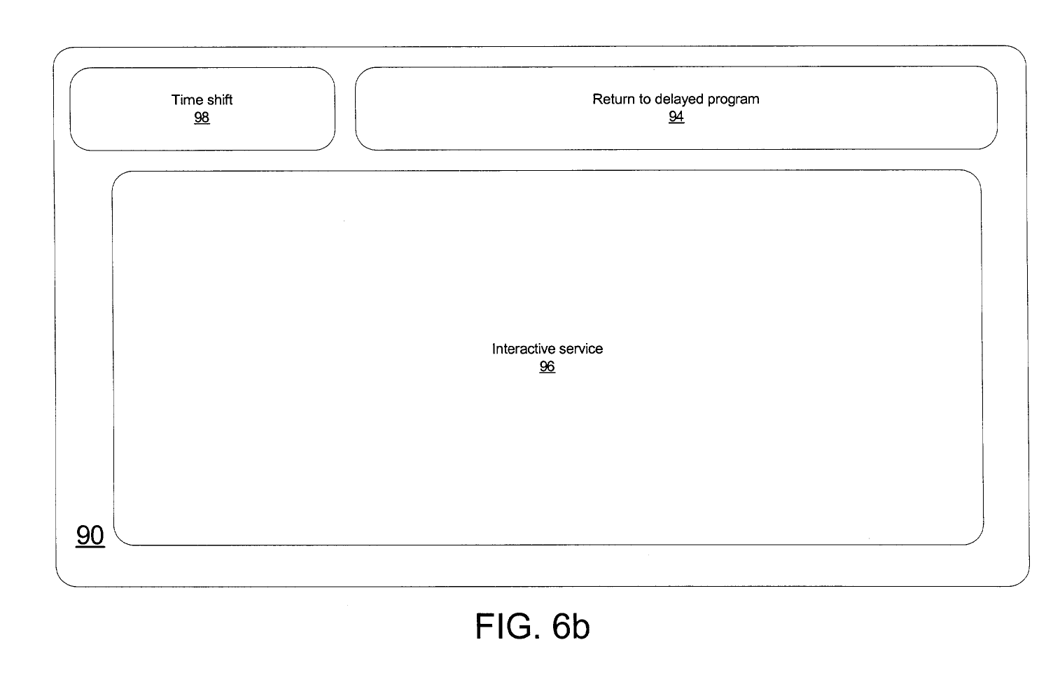

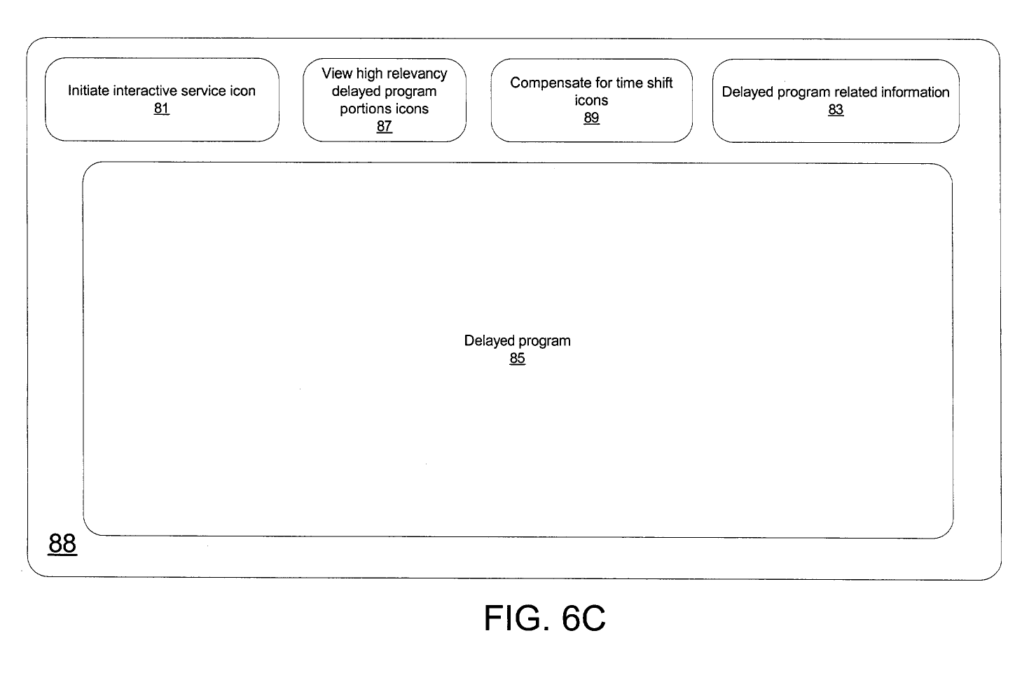

FIGS. 6A-6C illustrates various screens, in accordance with embodiments of the invention. FIG. 6A illustrates a first screen 80 that includes a program portion 86 for displaying a program, an initiating interactive service icon 82, for initiating an interactive service, view high relevancy program portions icons 87, for enabling the end-user to view a high relevancy program portion, and a program related information portion 84 for displaying program related information.

FIG. 6B illustrate a second screen 90 that is displayed when an end user receives an interactive service. Screen 90 includes interactive service portion 96, time shift portion 98 that illustrates the length of the interactive session, and a return to delayed program icon 94, that facilitates the reception of a delayed program.

FIG. 6C illustrates third screen 88 that is displayed when the end user receives a delayed program. Third screen 88 includes delayed program portion 85 for displaying the delayed program, initiate interactive service icon 81, view high relevancy delayed program portion icons 87, compensate for time shift icon 89 for initiating steps for compensating for the time gap (that may also be displayed) between the delayed program and the program and delayed program related information portion 83.

It is noted that when high relevancy portions are multicast to end-users the accesability of the end users may be limited to those high relevancy portion that do not exceed the currently displayed delayed program that they are watching, but this is not necessarily so.

Those skilled in the art will readily appreciate that various modifications and changes may be applied to the preferred embodiments of the invention as hereinbefore exemplified without departing from its scope as defined in and by the appended claims.

We claim:

1. A method for providing an interactive service to an end-user, the method comprising the steps of:
detecting a request from an end-user to participate in an interactive service, the end-user receiving a program; and
initializing an interactive session and enabling the end-user to receive a delayed program in response to a progress of the interactive service.

2. The method of claim 1 further comprising a step of monitoring the interactive service to determine a delay of the delayed program.

3. The method of claim 2 wherein the delay is responsive to a time period during which participation in the interactive service does not allow an effective display of the program.

4. The method of claim 1 wherein the step of enabling comprises linking the end-user to the delayed program.

5. The method of claim 1 wherein the step of enabling comprises a temporal storage of the program.

6. The method of claim 1 wherein the step of enabling comprises storing the delayed program at an end-user device.

7. The method of claim 1 wherein the step of enabling comprises storing the delayed program at a non-end-user device.

8. The method of claim 1 further comprising monitoring the program and providing a relevancy factor to various portions of the program.

9. The method of claim 8 further comprising a step of enabling end-users to receive a portion of the program in response to the relevancy factor of the portion.

10. The method of claim 8 further comprising multicasting program portions that are characterized by a high relevancy factor.

11. The method of claim 1 wherein enabling the end-user to receive the delayed program occurs once the interactive service ends.

12. The method of claim 1 wherein enabling the end-user to receive the delayed program occurs after the interactive service ends.

13. The method of claim 1 wherein enabling the end-user to receive the delayed program occurs once both the interactive service and the program may be presented simultaneously to the end-user.

14. The method of claim 1 wherein the interactive service comprises an interactive advertisement.

15. The method of claim 1 further comprising a step of compensating for a time gap between the program and the delayed program.

16. The method of claim 15 wherein compensating comprises skipping predefined advertisements.

17. The method of claim 16 wherein the predefined advertisements are associated with the interactive service.

18. The method of claim 16 wherein the predefined advertisements are associated with a program provider that provides the program.

19. The method of claim 15 further comprising monitoring the program and providing a relevancy factor to various portions of the program.

20. The method of claim 19 further comprising skipping at least one program portion in response to the relevancy factor of the portion.

21. An apparatus for providing an interactive service to an end-user, the apparatus comprising:
means for providing a program to an end-user;
a detector, communicatively coupled to the end-user, for detecting a request to receive an interactive service; and
an interactive service provider, communicatively coupled to the end-user, for providing the interactive service and for enabling the end-user to receive a delayed program in response to a progress of the interactive service.

22. The apparatus of claim 21 further comprising a monitor, coupled to the interactive service provider, operative to determine a delay of the delayed program.

23. The apparatus of claim 22 wherein the delay is responsive to a time period during which a participation in the interactive service does not allow an effective display of the program.

24. The apparatus of claim 21 wherein the interactive service provider is operable to link the end-user to the delayed program.

25. The apparatus of claim 24 wherein the interactive service provider is operable to temporarily store the program.

26. The apparatus of claim 21 wherein the apparatus is communicatively coupled to an end-user device and wherein the end-user device is operable to store at least a portion of the delayed program.

27. The apparatus of claim 21 wherein enabling comprises storing the delayed program at a non-end-user device.

28. The apparatus of claim 21 further comprising a program relevancy monitor operable to monitor the program and provide a relevancy factor to various portions of the program.

29. The apparatus of claim 28 wherein the means for providing the program is operable to enable the end-user to receive a portion of the program in response to the relevancy factor of the portion.

30. The apparatus of claim 28 wherein the means for providing the program is operable to multicast program portions that are characterized by a high relevancy factor.

31. The apparatus of claim 21 wherein the apparatus is further configured to enable the end-user to receive the delayed program once the interactive service ends.

32. The apparatus of claim 21 wherein the apparatus is configured to enable the end-user to receive the delayed program after the interactive service ends.

33. The apparatus of claim 21 wherein the apparatus is operable to enable the end-user to receive the delayed program once both the interactive service and the program may be presented simultaneously to the end-user.

34. The apparatus of claim 21 wherein the interactive service comprises an interactive advertisement.

35. The apparatus of claim 21 wherein the apparatus is further operable to compensate for a time gap between the program and the delayed program.

36. The apparatus of claim 35 wherein compensation comprises skipping predefined advertisements.

37. The apparatus of claim 36 wherein the predefined advertisements are associated with the interactive service.

38. The apparatus of claim 36 wherein the predefined advertisements are associated with a program provider that provides the program.

39. The apparatus of claim 35 further comprising a program relevancy monitor operable to monitor the program and provide a relevancy factor to various portions of the program.

40. The apparatus of claim 39 wherein the apparatus is further operable to skip at least one program portion in response to the relevancy factor of the portion.

41. A computer readable medium having code embodied therein for causing an electronic device to perform the steps of: providing a program to an end-user; detecting a request to participate in an interactive service; and initializing an interactive service and enabling the end-user to receive a delayed program in response to a progress of the interactive service.
